(19) United States
(12) Patent Application Publication
(10) Pub. No.: US 2004/0043652 A1
(43) Pub. Date: Mar. 4, 2004

(54) Initiator having integral features for orienting and holding an insertable electrical shunt

(75) Inventor: Timothy Edwards, Gilbert, AZ (US)

Correspondence Address: THOMAS J. BRINDISI, 20 28TH PLACE, SUITE B, VENICE, CA, 90291, US

(73) Assignee: Special Devices, Inc.

(21) Appl. No.: 10/231,991

(22) Filed: Aug. 30, 2002

(51) Int. Cl. H01R 29/00

(52) U.S. Cl. 439/188

(57) ABSTRACT

An initiator with a body having integral features for orienting and holding a shunt, and having integral features for orienting a mating electrical connector.

### BACKGROUND OF THE INVENTION

The present invention relates to electrical initiators, and more particularly, to an initiator with an electrical connector that includes a body with integral features for orienting and securely holding a shunt, and for orienting a mating electrical connector.

An electrical initiator, such as is used in the automotive airbag industry, typically includes a shunt (or shorting) assembly that is secured within the initiator and in contact with the initiator's terminals, so as to prevent accidental actuation of the initiator prior to its engagement with a mating connector. Such a shunt assembly is typically a roughly cylindrical piece having a diameter substantially larger than the diameter of the portion of the mating connector that the assembly is designed to receive. The assembly typically includes a metallic shunt clip insert, and typically engages with the initiator's metal or plastic retainer so as to secure it in position in the initiator. When in place, the shunt assembly typically provides a surface(s) that is used to orient and secure the mating connector. Such shunt assemblies are described in U.S. Pat. Nos. 5,733,135, 6,213,800, and 6,257,910, the disclosures of which are hereby incorporated by reference herein.

The use of such assemblies, however, is subject to certain disadvantages. First, because the entire shunt assembly is inserted into the initiator body rather than made an integral part thereof, minimizing any undesired movement of its surface(s) used to orient and secure the mating connector (and thus degraded ability to mate and shunt reliably) requires tight tolerances and very secure methods of connection, both of which may increase manufacturing cost. Second, orientation features must be provided in both the initiator and the shunt assemblies so as to ensure proper alignment of the shunt clip with the electrical terminals of the initiator. Third, locking features must be provided in both the initiator and shunt assemblies so as to lock such shunt assemblies in place in the initiator. Fourth, the fact that such shunt assemblies are relatively large and comprise more than one part tends to exacerbate all of the foregoing issues. Fifth, producing a shunt assembly requires a separate, dedicated tool(s) and manufacturing step(s), such as an insert mold tool and molding step.

The prior art also includes initiator assemblies that eliminate a separate shunt assembly through the use of an integrated shunt, such as is described in U.S. Pat. Nos. 5,334,025 and 5,944,945. These arrangements, however, are for use with coaxial mating connectors and do not appear readily amenable to modification for use with commonly-used connectors such as the serviceable, non-serviceable, or universal connectors used in the automotive airbag industry. Moreover, because these connectors are coaxial, they do not appear to provide any orientation features and instead appear to permit the mating connector to rotate freely. Thus, it is believed that hitherto, problems such as those mentioned above have not been addressed by providing an initiator with a body having integral features for orienting and holding a shunt and for orienting a mating electrical connector.

### SUMMARY OF THE INVENTION

An initiator according to the present invention includes a pair of electrical terminals for electrical contact with a mating electrical connector, and a shunt for establishing a short circuit between the electrical terminals when they are not in electrical contact with the mating connector. The initiator also includes integrally-formed means for orienting and securely holding the shunt in the initiator, and integrally-formed means for orienting the mating electrical connector with respect to the electrical terminals. The initiator may also optionally include means for securely holding the mating connector in place.

### BRIEF DESCRIPTION OF THE FIGURES

FIG. 1 is a transverse perspective view, partially in section, of an embodiment of an initiator assembly according to the present invention.

FIG. 2 is a bottom plan view of the initiator assembly of FIG. 1.

FIG. 3 is a sectional view of the assembly of FIG. 1 (through the line indicated in FIG. 5) without the shunt inserted.

FIG. 4 is a sectional view taken through the line A-A of FIG. 2.

FIG. 5 is a sectional view taken through the line B-B of FIG. 2.

FIG. 6 is a sectional view taken through the line C-C of FIG. 2.

FIG. 7 is a front view of the shunt of the embodiment depicted in the foregoing drawings.

FIG. 8 is a side view of the shunt.

FIG. 9 is a sectional view similar to that of FIG. 4, but with the mating connector inserted.

FIG. 10 is a sectional view similar to that of FIG. 6, but with connector inserted.

FIG. 11 in an end view of the mating connector.

### DETAILED DESCRIPTION OF A PREFERRED EMBODIMENT

The depicted preferred embodiment of the present invention is designed for use with an air bag inflator for discharging inflation fluid to inflate an air bag to protect an occupant of a vehicle when the vehicle is involved in a collision. The present invention is likewise applicable, however, to any other suitable application involving an electrical initiator having a connector that requires a shunt when not in use.

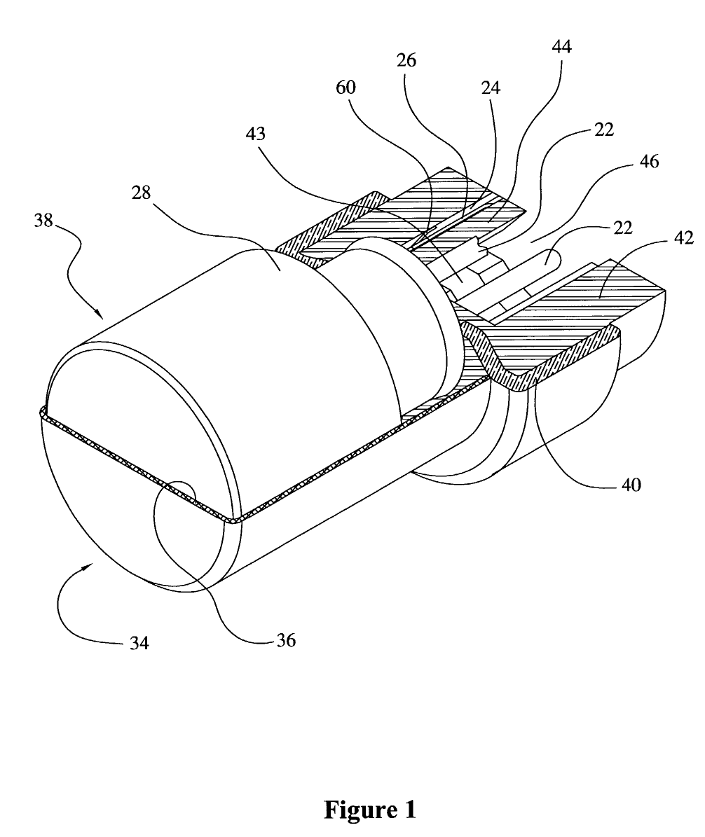

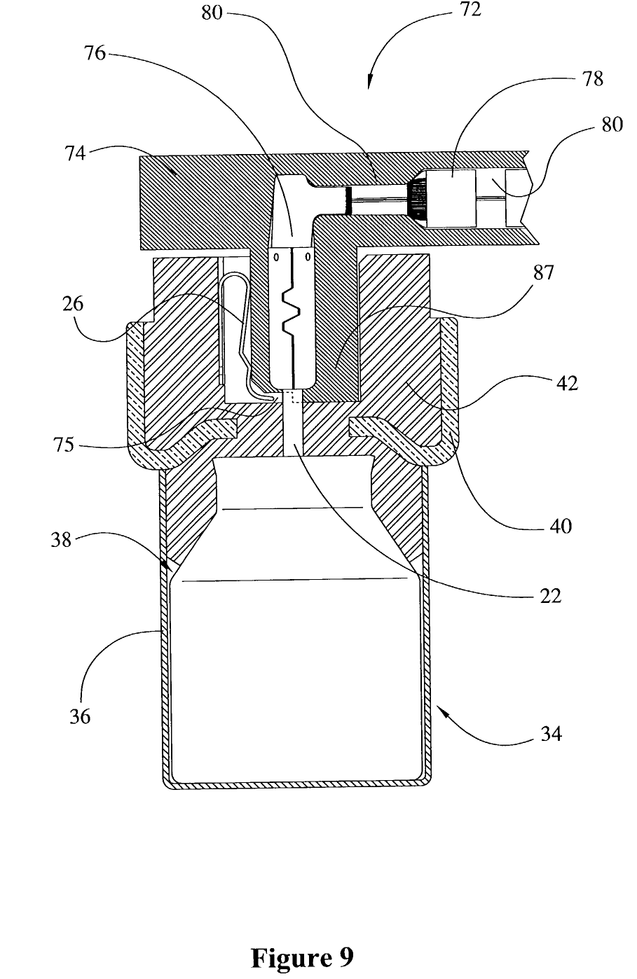

Referring to FIG. 1, an initiator assembly 34 includes an outer can 36 surrounding an igniter 38 and a molded body 42. The igniter 38 includes a charge can 28 enclosing a suitable pyrotechnic charge(s) and header assembly including an igniter wire (not shown) as is well-known in the art, and electrical terminals in the form of cylindrical metal pins 22 (the upper pin in FIG. 1 is partially cutaway to enhance the illustration). The pins 22 are electrically connected to the igniter wire, and, when the initiator assembly 34 is installed in the vehicle and connected with the vehicle's mating connector 72 as described below, the pins 22 are electrically connected with the mating connector 72. The mating connector 72 (see FIG. 9) is in turn connected to vehicle electric circuitry (not shown), including a sensor such as an accelerometer, for receiving an electrical signal to ignite the igniter wire of the igniter 38. The mating connector 72 is a commercially available part and is typically supplied by the manufacturer of the vehicle in which the initiator assembly 34 is mounted.

In addition to the igniter 38, the initiator assembly 34 includes a retainer 40 for securing the igniter to the housing of the inflator (not shown). The retainer 40 is preferably made of a metal suitable for cold forming, such as 304L stainless steel. A body 42 of plastic material encases and is in intimate contact with the retainer 40 and the igniter 38, thus attaching the retainer 40 to the igniter 38. The pins 22 of the igniter 38 extend axially out through the body 42 into the connector opening 46 of the initiator assembly 34. The body 42 is preferably injection molded, preferably at low pressures and temperatures, with one suitable material being nylon 6/6 with a 33% glass fill (e.g., ZYTEL®, from E. I. DuPont de Nemours & Co.). It will of course be recognized that various other materials could also be chosen that could be suitably injection molded at low pressures and temperatures, suitably adhere to the retainer 40 and to the igniter 38, and have suitably strength and durability to form the structures described below (e.g., the post 44). Alternatively, the body 42 could be an epoxy adhesive, or another material that is not injection molded.

To secure the igniter 38 to the retainer 40, the igniter and the retainer are positioned relative to each other in a die (not shown), with the igniter's pins 22 extending through the central aperture of the retainer 40. The plastic material of the body 42 in a molten form is then injected into the die where it adheres to the retainer 40, the igniter 38 and the pins 22.

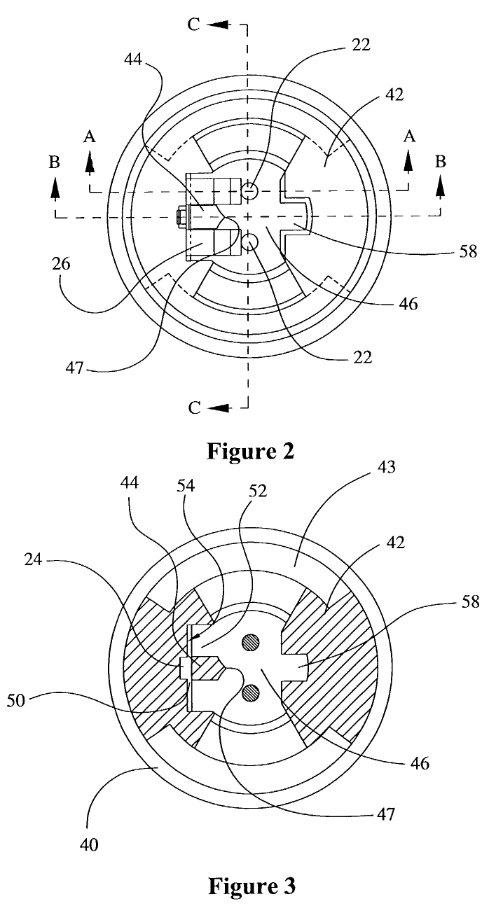

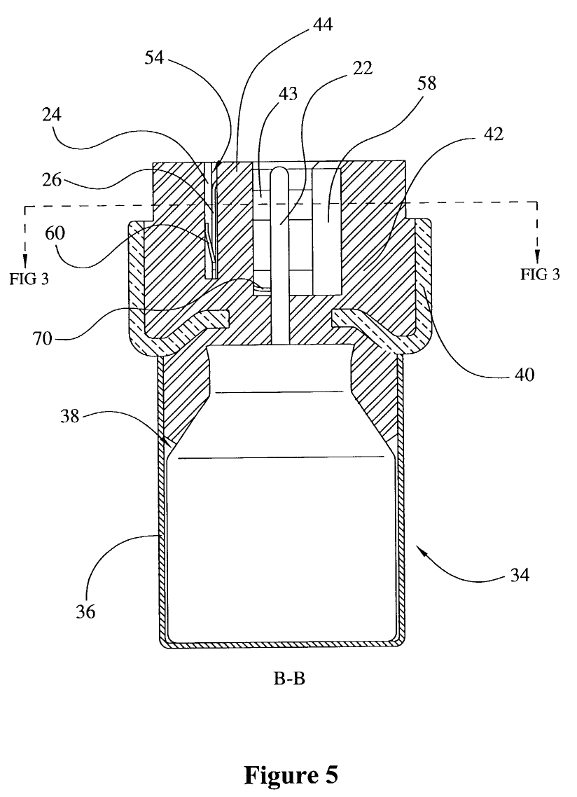

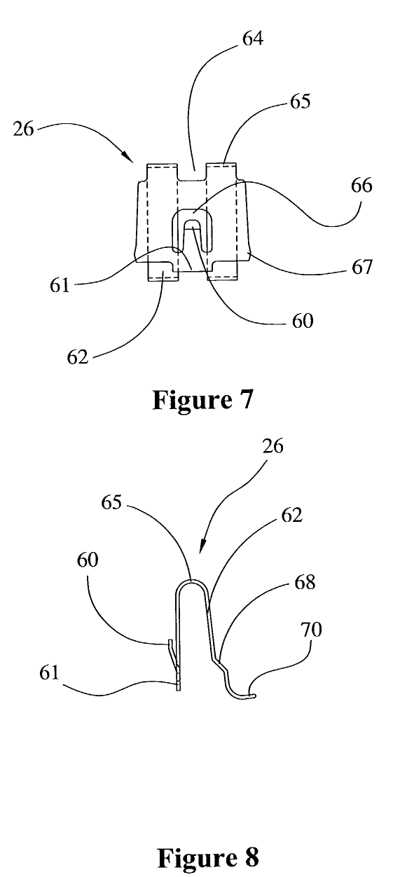

Referring now also to FIGS. 2-5, it will be seen that the connector opening 46 of the initiator assembly 34 is formed to include features for properly orienting the mating connector 72 and for receiving and holding in proper orientation the shunt 26 (which is described further below particularly with reference to FIGS. 7 and 8). These orientation features assure proper pin-to-connector polarity (ground/isolated) and prevent the mating connector from being installed backwards. Specifically, as can be seen from FIGS. 2, 3, and 5, an orientation channel 58 defined in the body 42 extends uniformly up from the bottom surface of the connector opening 46. On the opposite side of the pins 22, a post 44 formed in the body 42 also extends uniformly up from the bottom surface of the connector opening 46. The post 44 includes an orientation ridge 47 that is generally “V”-shaped, with the “V” pointing toward the orientation channel 58. As can best be seen from FIGS. 3 and 5, a ledge 50 extends uniformly up a short distance from the bottom surface of the connector opening 46, and a central portion of the ledge 50 merges with the adjacent bottom portion of the post 44. On the opposite side of this central portion of the ledge 50, a barb channel 24 defined into the body 42 extends uniformly up from the plane of the ledge 50. Along the remainder of the ledge 50 (i.e., the portions on either side of the central portion that is adjacent to the barb channel 24), a flat face 54 extends uniformly up from the ledge 50. Although it is not shown in the drawings for the sake of simplicity, it is preferable to bevel the upwardly-facing edges of the features of the connector opening 46, to the extent practical with the molding technique.

As described further below, the shunt 26 is simply inserted in the space 52 around the post 44, and it is oriented and securely held by the post 44, barb channel 24, face 54, and ledge 50. Thus, the features for orienting and holding the shunt, and the features for orienting the mating connector, are all formed during the same step as the forming of the initiator body, eliminating at least one separate part and corresponding manufacturing step. Moreover, the resulting monolithic structure is less prone to undesirable movement of non-integral parts that could reduce the ease and/or reliability of obtaining proper shunting and/or connection with the mating connector.

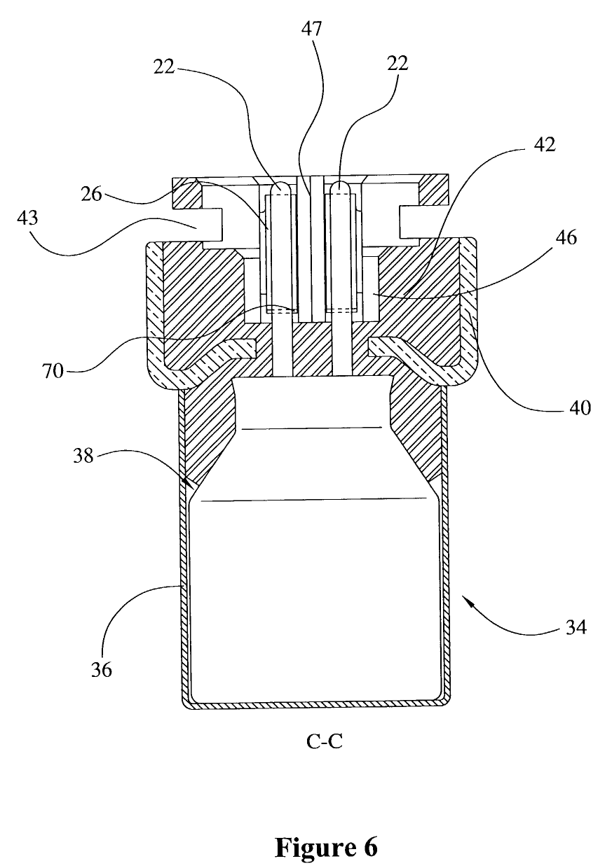

Referring now also to FIG. 6, it can be seen that the connector opening 46 of the initiator assembly 34 also preferably includes means for maintaining the mating connector 72 in electrical contact with the pins 22, such as windows 43 that may be formed in the body 42 as is well-known in the art to accept the locking wings of a standard mating connector as described below. Consequently, a further reduction of parts and manufacturing steps is realized, since the formation of the mating connector locking features also occurs as part of forming the initiator body 42 and the other orientation and holding features that are provided in the connector opening 46 as described above.

Referring now also to FIGS. 7 and 8, the shunt 26, which prevents accidental actuation of the igniter 38 prior to engagement of the mating connector 72 with the initiator assembly 34, is shown in more detail. The shunt 26 comprises (preferably substantially or wholly) an electrically conductive material, preferably a metal or metal alloy (preferably solid, clad, or plated) having suitable corrosion resistance, flexibility, and durability. In the depicted preferred embodiment, the shunt 26 may be stamped out of a blank of solid 0.007″ inch thick beryllium copper, so as to form legs 62, flares 67, and an abutment 61. Then, the still-flat piece may be further stamped to remove a “U”-shaped cutout 66 and form a barb 60 that extends at an angle (approximately 20°) away from the plane of the rest of the piece. As can be seen, the barb 60 terminates in a small end-portion that is bent so as to lie in a plane substantially parallel to the plane of the rest of the piece. After these stamping steps are completed, the shunt can then be formed into its final shape by forming the bends 65, inflections 68, and feet 70 into the legs 62, using a stamping die. As can be seen, forming the bends 65 in the legs 62 serves to define a post opening 64 at the top of the shunt 26.

The shunt 26 is then inserted into the connector opening 46 of the initiator assembly 34, so that its post opening 64 slides over and around the top of the post 44, and its legs 62 enter space 52. The shunt 26 is thus slid down along the face 54 of the body 42, with its barb 60 traveling down the barb channel 24 and its flares 67 in sliding contact with opposing portions of the body 42, until its abutment 61 reaches the ledge 50 formed in the body 42. The distance between the face 54 and the opposing portion of the post 44 is preferably selected to be slightly less than width of the barbed portion of the shunt 26, so that while the shunt is being slid into place, the barb 60 is under slight compression. This further ensures that once the abutment 61 reaches the ledge 50, the shunt 26 is securely locked in position with the barb 60 impinging against the face 54 and resisting upward movement with respect to the face 54. Thus, the shunt 26 is precluded from any substantial downward movement by the contact of the abutment 61 with the ledge 50, it is precluded from any substantial upward movement by the contact of the barb 60 against the face 54, it is precluded from any substantial lateral movement in a plane parallel with the face 54 by the contact between the flares 67 and the body 42 and the proximity of the legs 62 to the post 44, and, finally, the portion of the shunt 26 between the post 44 and the barb channel 24 and the face 54 is precluded from any substantial inward or outward movement by its contact with the post 44 and the barb channel 24 and the face 54. Substantial rotation in any direction of the shunt 26 (except for pivoting in space 52 of the legs 62 at their bends 65 as described below) is also substantially resisted by the foregoing contacts.

The dimensions of the bends 65, inflections 68, and feet 70 of the shunt 26 are also selected so that the overall width of the shunt 26 (not counting its barb 60) is slightly greater than the distance between the face 54 and the opposing portions of the pins 22, so that in order to insert the shunt 26 into the connector opening 46 as described above, its feet 70 must first be compressed inwardly a slight amount (e.g., a millimeter or so) so that they can pass by the pins 22 and the shunt 26 can fit between the face 54 and the pins 22 as shown in FIG. 2. This results in a degree of compression of the legs 62 when the shunt 26 is locked in place, which in turn ensures that the feet 70 reliably contact and electrically connect the corresponding pins 22 of the igniter 38. This connection establishes a short circuit between the pins 22 of the igniter 38 (when the mating connector 72 is not in electrical contact with the terminals) that does not extend through the bridgewire of the igniter 38, so that any stray electrical current that might be applied across the pins 22 of the igniter 38 does not result in actuation of the igniter.

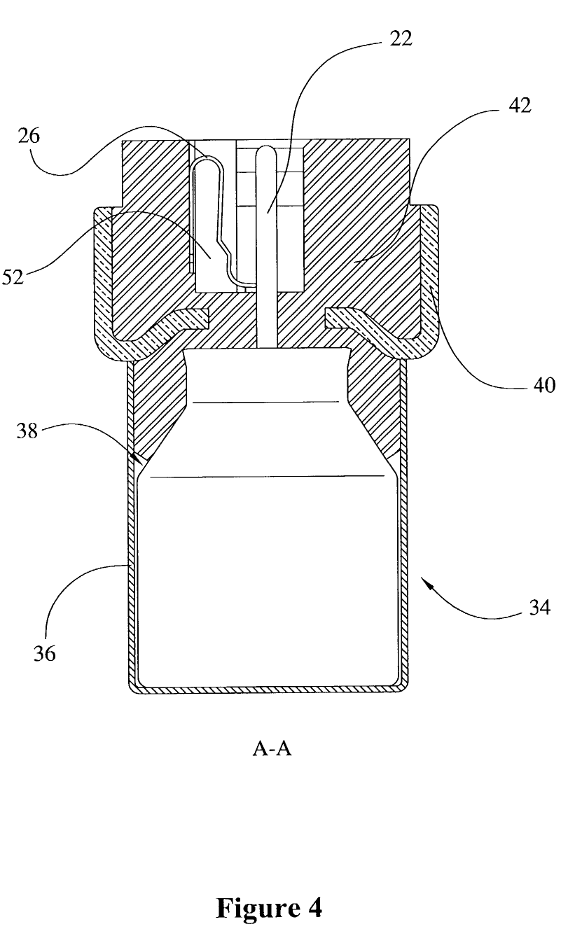

Finally, the length of the legs 62 is selected so that when the shunt 26 is inserted in place as described above, as shown in FIGS. 4 and 5, the feet 70 are slightly above (e.g., a few millimeters or so) the bottom surface of the connector opening 46. Thus, when the mating connector 72 is inserted, the feet 70 have room to pivot within space 52, downwardly and out of contact with the pins 22 as described below.

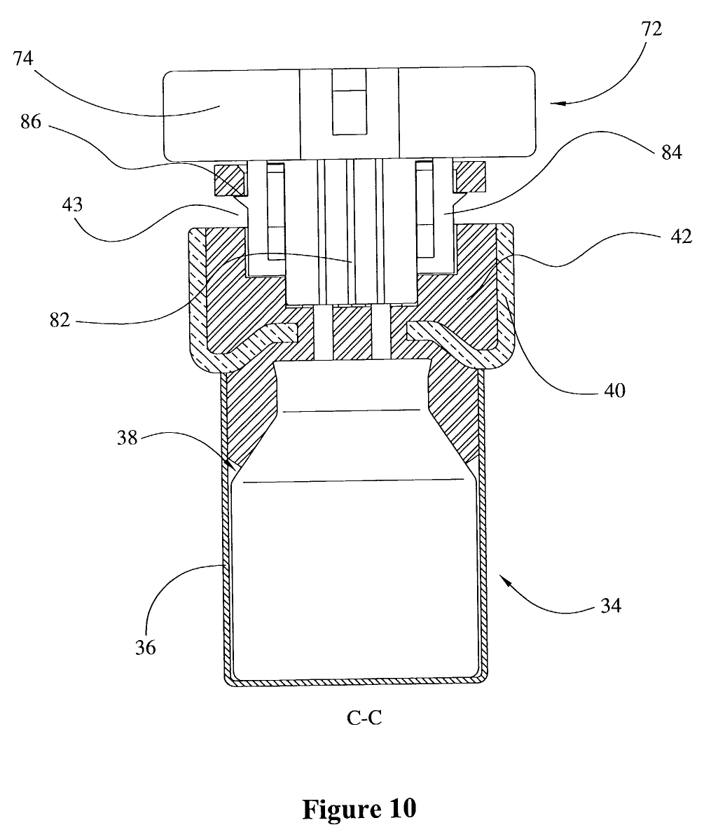

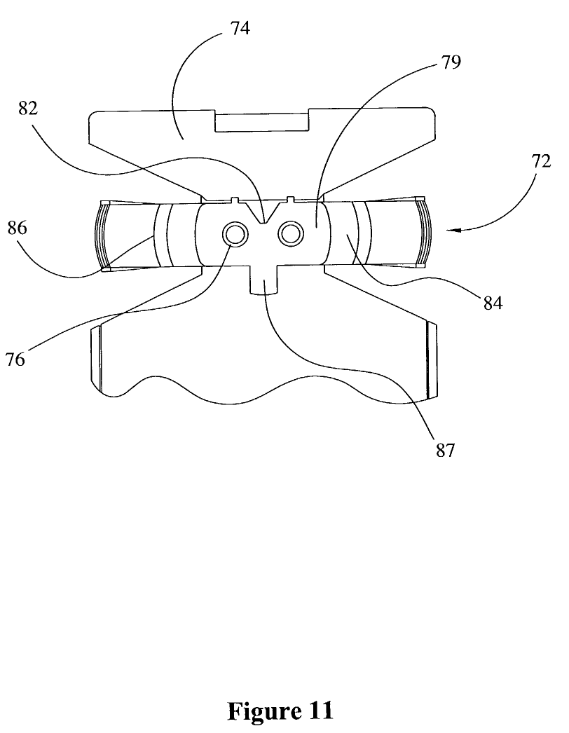

Referring now also to FIG. 9, when the initiator assembly 34 is installed with an airbag inflator in the vehicle, it is electrically connected to the vehicle electric circuitry by the mating connector 72. The mating connector 72 has a projecting portion made of an electrically insulating body 74 such as molded nylon, with contacts 76 encased in the projecting portion. The contacts 76 are connected by crimps 80 to lead wires 78 that extend away from the mating connector 72 and are connectable to vehicle circuitry, including the sensor, for generating an actuating signal for the igniter 38. The external configuration of the projecting portion of the mating connector 72 is adapted to mate in a particular orientation with the features of the connector opening 46, including the pins 22, post 44, orientation channel 58, and bottom surface of the connector opening 46. As can also be seen from FIGS. 10 and 11, the projecting portion of the mating connector 72 fits into the connector opening 46 of the initiator assembly 34, with a groove 82 on its front surface formed to mate with the orientation ridge 47 of the post 44, and with a bar 87 formed on its opposing surface to mate with the orientation channel 58.

Thus, when the mating connector 72 is aligned with its groove 82 and bar 87 in proper orientation with the orientation ridge 47 and orientation channel 58, respectively, the pins 22 of the igniter 38 are in proper alignment to be received in the contacts 76 of the mating connector 72 and establish electrical contact between the igniter 38 and the vehicle electric circuitry. Once the mating connector 72 is substantially inserted into the connector opening 46, its projecting portion makes contact with the inflections 68 of the shunt 26 and pushes the shunt's feet 70 away from the pins 22, disconnecting the short circuit established by the shunt 26. In this regard, the projecting portion is also preferably configured to enhance its engagement and accommodation of the shunt 26. Thus, a recess 75 is preferably provided at the end of the projecting portion, so that when the projecting portion is fully inserted into and reaches the bottom surface of the connector opening 46, there is a space between the projecting portion and the connector opening's bottom surface to accommodate the feet 70 of the shunt 26. Also, the part of the projecting portion that first makes contact with the inflections 68 of the shunt 26 is preferably beveled so as to make the engagement smoother.

The projecting portion of the mating connector 72 also preferably includes a pair of opposing wings 84 with locking tabs 86 (see FIG. 10) that are adapted to engage with the windows 43 of the body 42 and to securely interlock the mating connector 72 to the initiator assembly 34. With the projecting portion of the mating connector 72 disposed in the connector opening 46, the locking tabs 86 are received and engaged in the windows 43 (see FIG. 6) thus blocking movement of the mating connector 72 axially outwardly of the initiator assembly 34, that is, in a direction away from the igniter 38. This interlocking engagement maintains the mating connector 72 in electrical contact with the pins 22 of the igniter 38.

A preferred embodiment of an initiator with a body having integral features for orienting and holding a shunt, and having integral features for orienting a mating electrical connector, has thus been disclosed. It will be apparent, however, that various changes may be made in the form, construction, and arrangement of the parts without departing from the spirit and scope of the invention, the form hereinbefore described being merely a preferred or exemplary embodiment thereof. Therefore, the invention is not to be restricted or limited except in accordance with the following claims.

What is claimed is:

1. An electrical initiator including a connector for directly receiving a selected mating connector, comprising:
a) an initiator element;
b) two electrical terminals electrically connected to said initiator element so as to actuate said initiator element upon the application of a selected electrical signal; and,
c) a monolithic body attached to said initiator element, said monolithic body being formed of an electrically insulating material, said monolithic body including one or more mating connector orientation features, and said monolithic body further including one or more shunt orientation and holding features.

2. The initiator of claim 1, wherein said initiator is capable of directly receiving the selected mating connector in only a specific selected orientation with respect to said electrical terminals, and wherein when a selected electrically conductive shunt is provided in the initiator, it is securely held in electrical contact with both of said electrical terminals when the initiator is not connected with the mating connector.

3. The initiator of claim 1, further comprising an electrically conductive shunt.

4. The initiator of claim 1, wherein said monolithic body is formed of nylon.

5. The initiator of claim 1, wherein said initiator element is an igniter and said initiator is for use in an automotive airbag inflator assembly.

6. The initiator of claim 2, further comprising an electrically conductive shunt that is substantially or wholly comprised of metal and includes a pair of legs and a barb, said barb formed to engage one or more of said shunt orientation and holding features so that each of said pair of legs is securely held in electrical connection with a respective one of said electrical terminals so as to establish an electrical short circuit that does not go through the initiator element when the selected mating connector is not connected to the initiator.

7. The initiator of claim 6, wherein said one or more shunt orientation and holding features includes a barb channel, a flat face, and a shunt space.

8. The initiator of claim 7, wherein said electrically conductive shunt further includes flares on its sides, and a bottom abutment.

9. The initiator of claim 1, further including a post formed in said monolithic body.

10. The initiator of claim 9, wherein said one or more shunt orientation and holding features includes said post.

11. The initiator of claim 9, wherein said post includes a ridge, and said one or more mating connector orientation features includes said ridge.

12. The initiator of claim 11, wherein said one or more shunt orientation and holding features also includes said post.

13. The initiator of claim 1, wherein said one or more mating connector orientation features includes a channel.

14. The initiator of claim 12, wherein said one or more mating connector orientation features includes a channel, and wherein said channel is positioned in said monolithic body on the opposite side of said electrical terminals from said post.

15. The initiator of claim 2, wherein said monolithic body further comprises one or more mating connector retention features.

16. The initiator of claim 15, wherein said one or more mating connector retention features includes two opposing windows defined in said monolithic body.

17. A method of making an electrical initiator including a connector for directly receiving a selected mating connector, comprising the steps of:
d) providing an initiator element;
e) electrically connecting two electrical terminals to said initiator element so that when a selected electrical signal is applied to said electrical terminals, said initiator element is actuated; and,
f) attaching a monolithic body to said initiator element, said monolithic body being formed of an electrically insulating material, said monolithic body including one or more mating connector orientation features, and said monolithic body further including one or more shunt orientation and holding features.

18. The method of claim 17, further comprising the step of engaging an electrically conductive shunt with said shunt orientation and holding features of said initiator.

19. The method of claim 17, further comprising the step of forming one or more mating connector retention features in said monolithic body.

20. The method of claim 17, further comprising the step of forming in said monolithic body a post having an orientation ridge.
